(19) United States
(12) Patent Application Publication
(10) Pub. No.: US 2006/0020603 A1
(43) Pub. Date: Jan. 26, 2006

(54) Word database compression

(76) Inventors: Salvatore Lo Turco, Munich (DE); Nariyasu Hamamata, Stuttgart (DE)

Correspondence Address: William S Frommer;Frommer Lawrence & Haug, 745 Fifth Avenue, New York, NY, 10151, US

(21) Appl. No.: 10/491,392

(22) PCT Filed: Sep. 19, 2002
(86) PCT No.: PCT/EP02/10529

§ 371 Date: Oct. 25, 2004

(30) Foreign Application Priority Data
Oct. 2, 2001 (EP) 01123666.8

(51) Int. Cl. G06F 7/00

(52) U.S. Cl. 707/100

(57) ABSTRACT

The present invention relates to a method for storing a word database in a memory means of a mobile communication device of a wireless communication system, comprising the steps of sorting words of different languages in alphabetical order, and arranging the words in a word database in a tree-like structure whereby common prefixes shared by two or more succeeding words are only stored once in a node of the tree-like structure and the corresponding endings of the respective words are stored as leaves of the node, whereby the nodes and the leaves are references by respective control symbols so that the words can be accessed.

The present invention relates to a method for storing a word database in a memory means of a mobile communication device of a wireless communication system, a computer software product for performing the method and a mobile communication device comprising a word database stored according tithe new method.

Modern mobile communication devices, such as portable cell phones, personal digital assistants and the like, for wireless communication systems, such as the GSM, UMTS system and the like, offer the user the possibility of displaying messages, instructions, key functions and the like in many different languages. Further, when inputting written messages comprising character symbols and so on, to be transmitted to a communication partner, e.g. via the short message system (SMS system), modern mobile communication devices support the input of words, expressions and terms by presenting words or terms that the user most likely wanted to input. Input of words, sentences and longer messages via the usual restricted keypad of a mobile communication device is quiet cumbersome. Mobile communication devices tend to be very small and lightweight and thus have only a very delimited number of keys to be used for inputting characters, symbols, numbers and the like. Usually, several characters, numbers and symbols are allocated to a single key. Thus, in order to input a wanted character, number or symbol, a user has to push the corresponding key several times until the wanted input is reached in the sequence. In Germany and Europe, modern mobile communication devices provide support for the input of words, expressions, terms and the like, e.g. by the so-called T9 system, which enables the user to press a key, to which the wanted input is allocated, only once, whereby the control means, i.e. processor or the like, and the corresponding software of the communication device recognises on the basis of the order in which the keys had been pressed, which word, expression or term the user meant and presents a corresponding proposal. Hereby, the input time is significantly reduced and the operation comfort is drastically enhanced.

On the other hand, this kind of support system and the possibility of operating, the communication device in a multitude of languages necessitates a large word database to be stored in the communication device. Consequently, the memory space required for storing such a database in a mobile communication device is very large and increases with additional functions supporting the operation comfort.

The object of the present invention is therefore to provide a method for storing a word database in a memory means of a mobile communication device of a wireless communication system as well as a computer software product able to perform such a method and a mobile communication device, which allow to save memory space for storing the word-database.

The above object is achieved by a method for storing a word database in a memory means of a mobile communication device of a wireless communication system according to claim 1, comprising the steps of sorting words of different languages in alphabetical order, and arranging the words in a word database in a tree-like structure whereby common prefixes shared by two or more succeeding words are only stored once in a node of the tree-like structure and the corresponding endings of the respective words are stored as leaves of the node, whereby the nodes and the leaves are referenced by respective control symbols so that the words can be accessed.

The above object is further achieved by a computer software product for storing a word database in a memory means of a mobile communication device of a wireless communication system according to claim 8, said computer software product, when stored in a memory means of a processing device, being able to perform the method steps of the inventive method.

The above object is further achieved by a mobile communication device of a wireless communication system according to claim 9, with memory means for storing a word database stored according to the method steps of the inventive method, and control means for accessing the word database.

The underlying principle of the present invention is basically that it has been realised that a word database comprising a plurality of, words in different languages used in mobile communication devices contains a large number of words with common prefixes. Prefixes in this context are sequences of one, two or more characters at the beginning of a word. Hereby, the memory space required can be drastically reduced by sharing the common prefixes of a plurality of words arranged immediately succeeding each other in alphabetical order. According to the present invention, it is proposed to arrange the words in the word database in a tree-like structure whereby each common shared prefix is allocated to a node and the respective different word endings are the leaves of the tree. Here, it has to be understood that the term word does not only cover sequences of characters with a predefined meaning, but also combinations of characters and symbols, symbols only and so on with a predefined meaning to be used in the operation of a mobile communication device of a wireless communication system according to the present invention.

Advantageously, at least one control symbol is allocated to each of the nodes and the leaves. Hereby, a simple, quick and very effective access to the respective word of the database is possible. Further advantageously, before said sorting step, a step of detecting common words and sentences to be used in the mobile communication device and a step of replacing the detected common words by word references are performed. Hereby, the term sentence covers all kinds of messages consisting of two or more words, terms or expressions to be used in a mobile communication device for instructing a user, informing about the restive function of a soft key and the like. Hereby, a reference table comprising the common replaced words and the respectively allocated word references is formed. Preferably, strings are used as the word references. In this way, the required memory space for the word database can be further reduced by ensuring that common shared words in the various sentences are replaced by a reference with a significantly shorter necessary storing space:

Further advantageously, a data compression is performed on the word database after said arranging step. Hereby, a Borrows-Wheeler transformation algorithm is advantageously used.

In the following description, the present invention is explained in more detail with respect to special embodiments and in relation to the enclosed drawings, in which

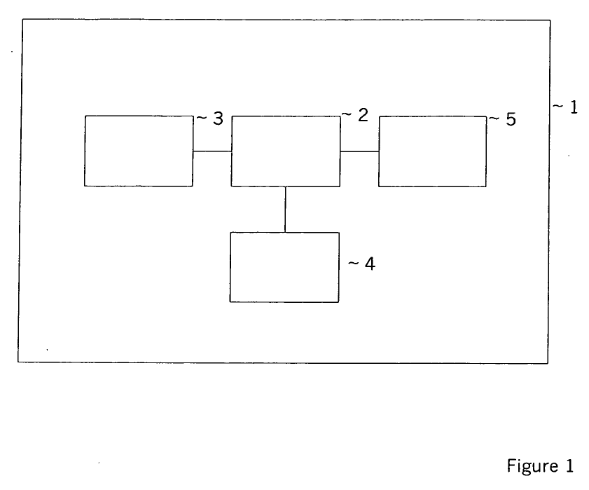

FIG. 1 shows a schematic representation of a mobile communication device according to the present invention,

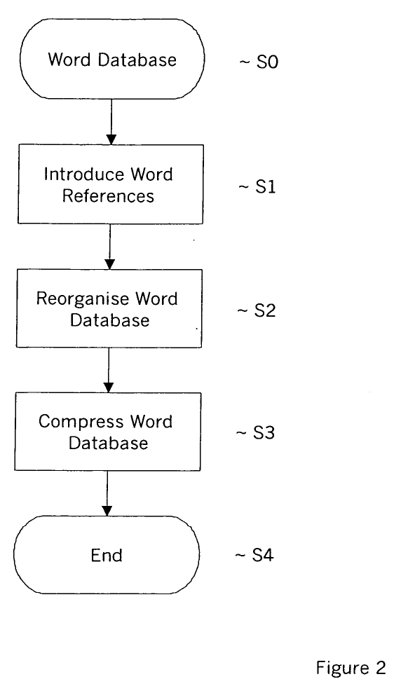

FIG. 2 is a flowchart showing the framework of a method according to the present invention,

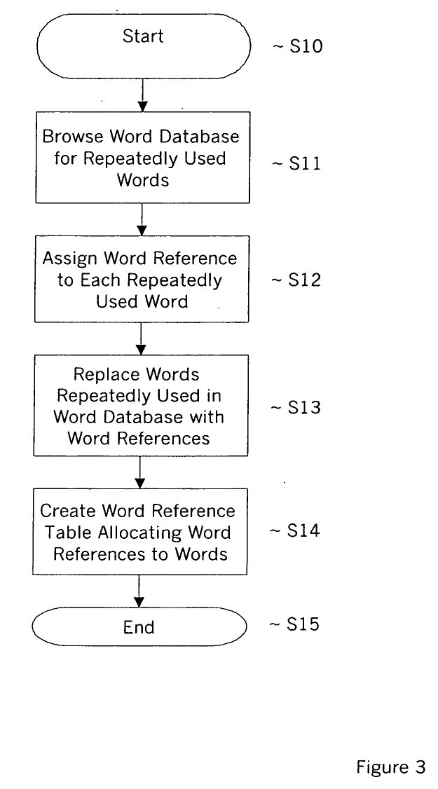

FIG. 3 is a flowchart showing the procedural steps for creating a word reference table according to the present invention, and

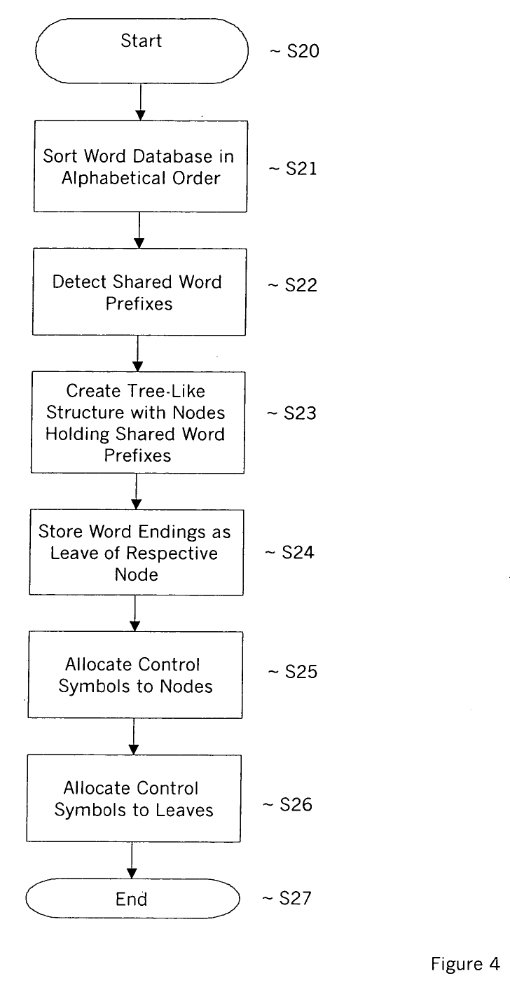

FIG. 4 is a flowchart showing the procedural steps for reorganising a word reference table according to the present invention.

FIG. 1 shows schematically a mobile communication device 1 for a wireless communication system, to which the present invention applies. Particularly, the mobile communication device 1 may be a portable cell phone, a personal digital assistant or the like, for operation in the GSM, UMTS system or the like. The mobile communication device 1 comprises a control means 2, such as a processor or the like, for controlling the main functions of the communication device, such as receiving and transmitting data in the communication system, controlling a display means 4, an input means 5 and all further elements necessary for the operation of the communication device 1. Further, a memory means 3 is provided and connected to the control means 2 for storing a word database according to the present invention. It is to be understood that FIG. 1 only shows elements of the mobile communication device necessary for the understanding of the present invention, but actually comprises all further elements necessary for the operation of the device, such as receiving/transmitting circuitry, display, antenna, etc.

Hereby, the word database is stored in the memory means 3 during the assembly of the communication device 1 according to the inventive method set out below.

A basic fact is that modern mobile communication devices are provided by the manufacturers for use in different continents, countries and languages. Therefore, the operation language, i.e. the language in which instructions, control functions and the like, are displayed or acoustically output by the communication device 1 can be set by a user to one of a plurality of languages. This on the other hand requires that the word database containing all words, symbols, expressions, terms and so on has to be stored in the memory means 3 of the communication device 1. Hereby, it has been recognised that at least the Western languages have a significant redundancy in characters, syllables, prefixes and even words within sentences. Further, several languages share common words. The present invention particularly aims to use these redundancies to save memory space for storing the word database in a memory means 3.

The framework of the method according to the present invention is illustrated in the flowchart of FIG. 2. Starting from the word database in Step S0, word references are introduced by a sub-process S1 made up of sequence of procedural steps. A word reference is hereby assigned to each word used at least twice in the word database, and the respective words a replaced by their assigned references. The next sub-process S2 again formed by a sequence of procedural steps reorganises the word database modified in S1 to a tree-like structure for to further reduce the storage capacity required. In a final step S3, the thus reorganised word database is further compressed using a state of the art data compression algorithm before the process comes to an end in S4.

FIG. 3 details the sub-process S1 described above. After starting the procedure in step S10, common words, i.e. words repeatedly used in sentences of the mobile communication device 1 are detected when browsing the word database in a first step S11. In the operation of a communication device 1, the communication device 1 often informs the user about different functionalities, gives him or her instructions, and the like, by using sentences in the form of two or more words. A sentence in the sense of the present application is not necessarily a grammatically correct sentence, but may be a short statement without even a verb or the like. The sentences used in a mobile communication device 1 have to be, prestored so that depending on the operation, application or respective functionality of the communication device 1, a corresponding sentence can be displayed or acoustically output to a user. Hereby, many of these sentences share common words, such as technical ones, e.g. SIM, PIN, . . . or not technical ones, e.g. active, cost, unknown, etc. This redundancy of words in the sentences stored and used in the communication device 1 is thus detected and a word reference is assigned to each of theses repeatedly used words in step S12. These common words are then replaced by word references in step S13. Of course, the word references are significantly shorter and require much less storage space than the replaced common words. At the same time, a reference table comprising the replaced common words and the respectively allocated word references is formed in step S14 so that, when a sentence is to be read from the memory means 3 and to be output to a user, the respective word reference can be replaced by the proper word or term to be output to the user. Advantageously, the word references are strings. In step S15 the described sub-process S1 finds its end.

The details of the second sequence S2 of procedural steps are given in the flowchart of FIG. 4. The words including, the ones replaced by word references in the first sub-process S1 are sorted in alphabetical order. This means, that all words, terms, expressions and the like in the different languages are sorted in alphabetical order in step S21. The following table 1 shows a segment of the correspondingly sorted words:
52) abajo
53) abbonamento
54) abbonato
55) abeceda
56) abfrage
57) abilitata
58) abilitato
59) abonado
60) abonament
61) abonamentu
62) abonat
63) abone
64) abonent
65) abonnee
66) abonnemangsA?vertrA$delse
67) abonnement
68) abonnent
69) abonnA?
70) abord
71) abr
72) abril
73) abroad
743 absent
75) abspielen
76) abuzivA?
77) abweisen
78) abwesend

Here it becomes evident, that many words share the same prefix, as in the shown example the prefix. “ab”. Theses shared prefixes are detected in step 22. Next, according to the present invention, the word database is arranged in a tree-like structure, whereby common prefixes shared by two or more alphabetically succeeding words are only stored once in a node of the tree-like structure in step S23, and the corresponding endings of the respective words are stored as leaves of the node in step S24. In the example of table 1, 26 subsequent words share the prefix “ab”. Storing the prefix only once in a single node saves 2×26=52 characters as compared to 2 characters plus one or more control symbols. Thus, the common shared prefixes are stored in nodes, whereby a control symbol is allocated to each node in step S25. Further, each word termination is allocated to a leave of the corresponding node in step S26, also with a corresponding control symbol. By the control symbols, the control means 2, when reading, out the words from the word database, can access the wanted words quickly and effectively.

In a third step or sub-process S3, respectively, the word database with the tree-like structure as well as the reference table are further compressed by a knot data compression algorithm, preferably a Borrows-Wheeler transformation algorithm. Hereby, the amount of words is further compressed.

The present invention therefore significantly reduces the memory space required for storing a word database in the memory means 3 of a mobile communication device 1. Hereby, the compression method described above can be implemented as a computer software product in a corresponding processing device to be used when manufacturing and assembling mobile communication devices 1 according to the present invention.

1. Method for storing a word database in a memory means of a mobile communication device of a wireless communication system, comprising the step of sorting words of different languages in alphabetical order, and
arranging the words in a word database in a tree-like structure whereby common prefixes shared by two or more succeeding words are only stored once in a node of the tree-like structure and the corresponding endings of the respective words are stored as leaves of the node, whereby the nodes and the leaves are referenced by respective control symbols so that the words can be accessed.

2. Method according to claim 1, characterized in,
that at least one control symbol is allocated to each of the nodes and the leaves.

3. Method according to claim 1, characterized in,
that before said sorting step a step of detecting common words in sentences to be used in said mobile communication device and a step of replacing said detected common words by word references are performed.

4. Method according to claim 3, characterized in,
that a reference table comprising the common replaced words and the respectively allocated word references is formed.

5. Method according to claim 3, characterized in,
that strings are used as word references.

6. Method according to claim 1, characterized in,
that after said arranging step a compression is performed on the word database.

7. Method according to claim 6, characterized in,
that in said compression step a Borrows-Wheeler transformation algorithm is used.

8. Computer software product for storing a word database in a memory means of a mobile communication device of a wireless communication system, said computer software product, when stored in a memory means of a processing device, being able to perform the method steps of claim 1.

9. Mobile communication device of a wireless communication system, with memory means for storing a word database stored according to the method steps of claim 1, and
control means for accessing the word database.
